(19) United States
(12) Patent Application Publication
(10) Pub. No.: US 2002/0151656 A1
(43) Pub. Date: Oct. 17, 2002

(54) Modified Carboxylated polyolefins and their use as adhesion promoters for polyolefin surfaces

(76) Inventors: Kevin Alan Williams, Mount Carmel, TN (US); Robert Lee Eagan, Batesville, AR (US); Lisa Kay Templeton, Kingsport, TN (US); Richard Leon McConnell, Kingsport, TN (US)

Correspondence Address: Rose M. Allen, Eastman Chemical Company, P.O. Box 511, Kingsport, TN, 37662-5075, US

(21) Appl. No.: 09/943,561

(22) Filed: Aug. 30, 2001

Related U.S. Application Data
(60) Provisional application No. 60/267,829, filed on Feb. 9, 2001.

(51) Int. Cl. C08F 120/08

(52) U.S. Cl. 525/327.4; 525/329.7; 525/384

(57) ABSTRACT

The present invention describes solvent and water based primer compositions comprising carboxylated polyolefins that have been modified with one or more polyfunctional alcohols. The carboxylated polyolefins are obtained by the reaction of polyolefins with unsaturated esters, unsaturated acids, unsaturated anhydrides, acrylic monomers, or mixtures thereof. The carboxylated polyolefins are then further modified by reaction with one or more polyfunctional alcohols. These modified polyolefins may also contain pendant carboxyl groups, which have the propensity to form hydrophilic salts with amines, therefore rendering the modified polyolefins water-dispersible. These primer compositions are useful for significantly improving the adhesion of paints to various plastic and metal substrates.

This application claims the benefit of U.S. Provisional Application Serial No. 60/267,829, filed Feb. 9, 2001.

### BACKGROUND OF THE INVENTION

Molded plastic parts are widely used in automobiles, trucks, household appliances, graphic arts and the like. Frequently these plastic parts are made from polyolefins such as polyethylene, ethylene copolymers, polypropylene, propylene copolymers and polyolefin blends with other polymers. One such blend is a thermoplastic polyolefin (TPO), which is a rubber-modified polypropylene. Frequently, these plastic parts have to be painted to match the color of painted metal parts that are also present in the automobile, appliance or other items. Typical paints do not adhere well to these plastic parts. Thus, adhesion-promoting primers are needed to improve the adhesion of the paints to the polyolefin materials.

Although chlorinated polyolefins, particularly chlorinated, maleated crystalline polypropylene polymers are effective for this purpose, they have very limited solubility in anything other than aromatic or chlorinated solvents. The U.S. Federal Clean Air Act of 1990 limits the amounts of solvents that are on the Hazardous Air Pollutants (HAPs) list that can be used in some areas, and most practical aromatic and chlorinated solvents for use in coatings applications are on the HAPs list. There are some applications where a non-chlorinated adhesion promoter is desired. Other systems proposed for use as primers are based on maleated amorphous polyolefins, which are dissolved in aromatic solvents such as xylene and toluene.

Attempts have been made to provide water based paints and primers for the automotive and appliance industries but these systems generally are not thought to be as effective as solvent based systems. There have been several patents issued pertaining to the modification of polyolefins to provide an adhesion-promoting primer composition for paint topcoats onto polyolefin surfaces.

U.S. Pat. No. 4,146,590 describes a process improvement for the production of a modified polyolefin resulting in high strength and a less irritating odor during processing. In this process polyfunctional compounds are reacted with residual unsaturated carboxylic acids or anhydrides contained in the polyolefins and that have not been grafted to polyolefins during the extruder free radical grafting process. After reaction of the polyfunctional compounds with the unreacted carboxylic acid monomer found in the polyolefin an irritating odor is eliminated when the polyolefin is further processed at high temperatures.

U.S. Pat. No. 4,299,754 describes a method for producing a modified propylene-ethylene copolymer, by graft copolymerization with maleic acid or anhydride, resulting in an adhesion-promoting composition for polyolefin surfaces. The resulting modified polymer contains only anhydride or acid functionality for crosslinking with the various paint topcoats. These compositions do not contain free hydroxyl groups or combinations of carboxyl and hydroxyl groups for crosslinking with the melamine-based topcoats, which tends to make the primer/topcoat system water-sensitive when exposed to high temperature and humidity conditions.

U.S. Pat. No. 4,461,809 describes a surface-treating agent used as an undercoat on the surface of a polyolefin shaped article to be coated with paint. This surface-treating agent is composed of a solution of a modified polymer in organic solvent. The modified polymer is prepared by graft copolymerization of a propylene-ethylene copolymer with an alkyl ester of a monolefinic dicarboxylic acid. The alkyl moiety of the alkyl ester is described by the general formula CₙH₂ₙ₊₁, such as methyl, ethyl, n-propyl, n-butyl, isopropyl, octyl, or 2-ethylhexyl.

U.S. Pat. No. 4,632,962 describes a method for graft modifying a polyolefin with hydroxyl functional groups through an imide linkage. These modified polyolefins are made by grafting an anhydride functional group to a polyolefin chain and then reacting the anhydride group with an amine substituted organic alcohol to produce an imide. The resulting imide group on the polyolefin contains hydroxyl groups for crosslinking with various topcoats.

U.S. Pat. No. 4,966,947 describes a method for graft modifying a chlorinated polyolefin with hydroxyl functional groups through an imide linkage. These modified polyolefins are made by grafting an anhydride functional group to a chlorinated polyolefin and then reacting the anhydride group with an amine substituted organic alcohol to produce an imide. The resulting imide group on the chlorinated polyolefin contains hydroxyl groups for crosslinking with various topcoats.

U.S. Pat. No. 4,997,882 describes an acid or anhydride grafted chlorinated polyolefin that has been reacted with a monoalcohol and a polyepoxide. The composition described in this patent is prepared by grafting an unsaturated acid or anhydride onto a chlorinated polyolefin to form an acid or anhydride modified chlorinated polyolefin resin. This resin is then reacted with an organic monohydric alcohol to form an esterified product containing acid functionality. The resulting esterified product is then further reacted with a polyepoxide to form the ungelled modified chlorinated polyolefin resin. The resulting product is then formulated into a coating composition for a thermoplastic polyolefin substrate.

U.S. Pat. No. 5,030,681 discloses a coating resin composition obtained by graft-polymerizing an unsaturated carboxylic acid to a chlorinated polyolefin in a solvent, esterifying all unsaturated carboxylic acid present in the reaction system, and mixing the obtained composition with a urethane prepolymer.

U.S. Pat. No. 5,135,984 describes a method for modifying a chlorinated polyolefin with maleic anhydride and an acrylic-modified hydrogenated polybutadiene. This method involves the graft copolymerization of the chlorinated polyolefin with the maleic acid anhydride and acrylate modified hydrogenated polybutadiene by heating the mixture in the presence of a peroxide initiator. This results in an acrylic and maleic anhydride modified chlorinated polyolefin.

U.S. Pat. No. 5,143,976 describes a resin composition containing graft copolymers of acrylic monomers (A) and polydiene (B) grafted onto a chlorinated polyolefin (C). The polyolefin resin compositions composed of the acrylic oligomers contain hydroxyl or carboxyl groups and/or certain acrylic oligomers.

U.S. Pat. No. 5,523,358 describes the grafting of various unsaturated monomers to polyolefins in which an organic solvent is used to swell the polyolefin during the grafting step.

U.S. Pat. No. 5,587,418 describes a method for producing a graft copolymer for use as a primeness colored basecoat on polyolefin surfaces. The graft copolymer is obtained by copolymerizing acrylic monomers, unsaturated carboxylic acids, and acrylic monomers containing hydroxyl groups with certain chlorinated polyolefins.

U.S. Pat. No. 5,811,489 describes a method for producing a coating resin composition based on a graft-copolymerized resin. This coating resin composition comprises a graft copolymerized resin prepared by graft copolymerizing a monomer containing an ethylenic unsaturated bond and a monomer containing ethylenic unsaturated bond and a hydroxyl group onto a mixed resin of (1) a carboxyl group-containing chlorinated polyolefin resin obtained by graft copolymerizing an unsaturated carboxylic acid or anhydride onto a polyolefin followed by chlorination and (2) a chlorinated polyolefin resin obtained by simultaneously oxidizing and chlorinating a polyolefin using at least one oxidizing agent selected from air, oxygen and ozone, an isocyanate compound or an alkyl-etherified amino resin as a curing agent.

U.S. Pat. No. 5,863,646 describes a liquid coating composition comprising a mixture of a substantially saturated polyhydroxylated polydiene polymer, having terminal hydroxyl groups, with a chlorinated polyolefin, a film forming polymer, and a carrier material. The coating can be applied to plastic substrates to improve the adhesion of subsequently applied coatings. U.S. Pat. No. 6.001,469 describes a similar composition as described in U.S. Pat. No. 5,863,646 and its use as an adhesion promoting coating that can be applied directly onto thermoplastic and thermosetting plastic substrates.

European patent application 1036817 A1 discloses a polyamide-modified polyolefin composition, which is obtained by reacting an unsaturated carboxylic acid anhydride modified polyolefin, having a specified molecular weight range, with a polyamide, having a specified molecular weight range. The resulting composition is described as having excellent adherence to polyolefin substrates without tack.

U.S. Application Ser. No. 09/342,181, filed Jun. 29, 1999 (assigned to Eastman Chemical Company) and published as WO 00/00558 describes solvent-based primer compositions containing 0.5 to 40 weight percent of a modified polyolefin and a solvent selected from the group consisting of ester solvents, ketone solvents, aliphatic solvents, aromatic solvents, and mixtures thereof. The polyolefins described in this report have been graft-modified with unsaturated acids, anhydrides, or esters. These modified polyolefins are reported to have good utility as primers for polyolefins substrates when topcoated with melamine based and 2-part polyurethane paints. Although these modified polyolefins provide good initial crosshatch adhesion of melamine based topcoats and good solvent resistance after application, they are deficient in water resistance, especially under high temperature and humidity conditions.

U.S. Pat. No. 6,262,182, assigned to Eastman Chemical Company, describes a solution process for the modification of certain polyolefins with an unsaturated anhydride, unsaturated acid or unsaturated ester. These modified polyolefins are reported to have good utility as primers for polyolefin substrates when top coated with melamine based and two-part polyurethane paints. Although the modified polyolefins provide good initial crosshatch adhesion of melamine based topcoats and good solvent resistance after application, they are deficient in water resistance, especially under high temperature and humidity conditions.

Thus, it is desirable to provide both solvent and water based primers that provide good adhesion of paints to polyolefin substrates; that are environmentally acceptable; and that provide good solvent and water resistance when topcoated with urethane or melamine topcoats.

### SUMMARY OF THE INVENTION

The present invention describes modified carboxylated polyolefins and their use in solvent and water based, adhesion-promoting primer compositions. The carboxylated polyolefins are prepared by reacting polyolefins with unsaturated esters, unsaturated acids, unsaturated anhydrides, acrylic monomers, or mixtures thereof. The carboxylated polyolefins are then further modified by reaction with one or more polyfunctional alcohols. The modified carboxylated polyolefins are useful in solvent and water based primer compositions and have been found to significantly improve the adhesion of paints and/or melamine or urethane based topcoats to various plastic and metal substrates.

### DETAILED DESCRIPTION OF THE INVENTION

Useful polyolefin polymers for practice of the invention include polyethylene, ethylene copolymers containing alpha olefins having 2 to about 10 carbon atoms, polypropylene, propylene copolymers containing ethylene or alpha olefins having from 4 to about 10 carbon atoms, poly(1-butene), 1-butene copolymers containing ethylene or alpha olefins having 3 to about 10 carbon atoms and the like. The term copolymer means that the olefin polymer may contain one or more comonomers. In addition, mixtures of the previously mentioned polyolefins may be used in this process as opposed to using a single polyolefin. The polymers may be crystalline, semicrystalline or amorphous but amorphous ones are preferred because of their improved solubility in typical coating solvents. A preferred copolymer is an ethylene-propylene copolymer comprised of about 80 mole percent propylene and about 20 mole percent ethylene.

Monomers useful in the initial step of carboxylation of a polyolefin include unsaturated esters, unsaturated acids, unsaturated anhydrides, and vinyl monomers or acrylic monomers, such as alkyl acrylates or alkyl methacrylates. Useful monomers include, but are not limited to, maleic anhydride, citraconic anhydride, itaconic anhydride, glutaconic anhydride, 2,3-dimethylmaleic anhydride, maleic acid, fumaric acid, citraconic acid, mesaconic acid, glutaconic acid, acrylic acid, methacrylic acid, crotonic acid, 2-pentenoic acid, 2-methyl-2-pentenoic acid, dimethyl maleate, diethyl maleate, di-n-propyl maleate, diisopropyl maleate, dimethyl fumarate, diethyl fumarate, di-n-propyl fumarate, diisopropyl fumarate, dimethyl itaconate, methyl acrylate, hydroxyethyl acrylate, ethyl acrylate, methyl methacrylate, ethyl methacrylate, methyl crotonate, ethyl crotonate and mixtures thereof.

Preferably, the concentration of the unsaturated anhydride, unsaturated acid, unsaturated ester, vinyl monomer or acrylic monomer is in the range of about 1 to about 20 weight percent based on the weight of polyolefin. A more preferable range is from about 2 to about 12 weight percent. A range of about 4 to about 12 weight percent is most preferred.

These monomers are readily grafted to polyolefins either in the melt phase or in the solution phase using radical initiators, such as organic peroxides or azo compounds, as the catalyst. A preferred method includes the grafting of the monomers in a solution process according to the procedure described in U.S. patent application Ser. No. 09/453,892, incorporated herein by reference.

The reaction temperature is usually controlled by the half-life of the peroxide initiator. The half-life of the initiator at a given reaction temperature should be about one third to about one sixth of the reaction time. By knowing the half-life of the initiator at a specific temperature, a suitable reaction time can be quickly determined. The more stable the initiator, the longer the reaction time will be. For example, a peroxide may be suitable if its half-life at a given reaction temperature is 10 hours or less.

Examples of organic peroxides, which may be used, include, but are not limited to, dibenzoyl peroxide, tert-amylperoxy 2-ethylhexanoate, tert-butylperoxy 2-ethylhexanoate, tert-butylperoxy isobutyrate, and tert-butylperoxy isopropyl carbonate, tert-butylperoxy 3,5,5-trimethylhexanoate, 2,5-dimethyl-2,5-di(benzoylperoxy)hexane, tert-butylperoxy acetate, tert-butylperoxy benzoate, n-butyl 4,4-di(tert-butyl)valerate, dicumyl peroxide, tert-butylcumyl peroxide, di(2-tert-butylperoxy isopropyl)benzene, 2,5-dimethyl-2,5-di(tert-butylperoxy)hexane, di(tert-butyl) peroxide, 2,5-dimethyl-2,5-di(tert-butylperoxy)-3-hexyne, tert-butyl hydroperoxide, cumyl hydroperoxide and mixtures thereof.

Examples of azo compounds useful as radical initiators include, but are not limited to, 2,2′-azobisisopropionitrile, 2,2′-azobisisobutryonitrile (AlBN), dimethyl azoisobutyrate, 1,1′azobis(cyclohexanecarbonitrile), 2,2′-azobis(2-methylpropane) and mixtures thereof. Typical concentrations of radical initiators range from about 0.1 to about 20 weight %, based on the weight of the polyolefin. A more preferable range is from about 0.2 to about 10 weight percent.

The addition of the monomers and a radical initiator can be carried out under numerous scenarios. For example, these monomers can be added before the radical initiator, concurrent with the radical initiator or subsequent to the radical initiator. The monomer can be added in either the molten state or as a solution in a solvent that does not interfere with the grafting reaction. Likewise the radical initiator can be added in either solid or liquid form. It is also possible to charge a solution of the grafting monomer containing the initiator in a solvent that does not interfere with the desired reaction. The solvent used for this purpose can be the same or different from the reaction solvent. Preferably the solvent has a low volatility such that it flashes off and does not dilute or contaminate the reaction solvent. Preferred solvents for dissolving the grafting monomer include ketone solvents such as acetone and methyl ethyl ketone. For example, maleic anhydride and hydroxyethyl acrylate are very soluble in these two solvents but the polyolefin is not. In general, ketone solvents are used in amounts that do not cause the polyolefin to precipitate.

The grafting process is typically conducted in solution at temperatures ranging from about 50° C. to about 300° C., depending on the choice of solvent. The reaction may be carried out at temperatures up to and including the boiling point of the solvent. A more preferable temperature range is from about 70° C. to about 240° C.; and a most preferred range is from about 80° C. to about 220° C.

Following the completion of the grafting reaction, the reaction product may be used as is, or optionally the solvent used in the reaction may be removed by distillation at either ambient pressure or more preferably at reduced pressure. As a way of reducing cost in the process, the solvent may be recovered and recycled in subsequent batches. Solvents with relatively low boiling points are typically easier to remove and consequently more desirable for use in this process. Preferred solvents include tert-butylbenzene (b.p. 169° C.) and anisole (b.p. 154° C.) because of their lack of reactivity and ease of removal.

It is also possible to provide modified carboxylated polyolefins containing free hydroxyl groups by co-grafting mixtures of hydroxyl-functional acrylic monomers with unsaturated acids, unsaturated esters, unsaturated anhydrides, acrylic monomers and the like.

In the process of the present invention, the carboxyl functional portion of the polyolefin (i.e. carboxylated polyolefin) is further reacted (fully or partially ) with one or more polyfunctional alcohols. Suitable alcohols will generally have at least two hydroxyl groups and frequently will have 3, 4 or more hydroxyl groups. Useful alcohols include, but are not limited to, trimethylolethane, pentaerythritol, trimethylolpropane, 1,6-hexanediol, 1,4-cyclohexanediol, 1,4-cyclohexanedimethanol, 2,2,4-trimethyl-1,3-pentanediol, 2-ethyl-1,3-hexanediol, diethylene glycol, triethylene glycol, polyethylene glycols, glycerol, polyester polyols, acrylic polyols, polyurethanepolyols, glucose, sucrose and the like.

The polyol modification reaction may be carried out in the presence or absence of a solvent. However, it is preferred to conduct the reaction in a solvent at temperatures in the range of 50° C. to 250° C. Any solvent in which the carboxylated polyolefin is soluble may be used. Suitable solvents include aromatic hydrocarbon solvents such as benzene, toluene, xylene, tert-butylbenzene, chlorinated solvents, aliphatic hydrocarbon solvents such as naphtha, mineral spirits, and hexane, ester solvents such as propyl acetate and butyl acetate as well as ketones such as methyl amyl ketone. Mixtures of solvents may be used if desired. The amount of polyol used will generally be in the range of about 0.01 to about 25 weight % based on the weight of the carboxylated polyolefin.

It may or may not be desirable to modify the carboxylated polyolefin with polyol in the grafting reaction solvent such as tert-butyl benzene. This allows the polyolefin to be further modified, if desired, by grafting other acrylic monomers onto the polyolefin backbone after polyol modification of the carboxyl group(s). For a solvent-based product, it may be desirable or convenient to conduct the polyol modification reaction in the solvent to be used for dissolving the final resin.

If the carboxylated polyolefin contains anhydride groups, no catalyst is required to react this material with the polyfunctional alcohols to yield the corresponding monoester and half acid groups. However, if desired, the remaining half acid groups on the polyolefin may then be further reacted with polyfunctional alcohol in the presence of excess polyfunctional alcohol and at higher temperature to yield the corresponding diester. A catalyst may or may not be needed to completely esterify all of the half acid groups.

If the polyolefin initially contains only carboxylic acid groups, the polyol modification reaction may be performed using an excess of polyfunctional alcohol at higher temperatures to yield the corresponding monoester groups. A catalyst may or may not be needed to completely esterify all of the half acid groups.

If the carboxylated polyolefin is prepared by grafting an ester monomer such as dimethyl maleate to the polyolefin substrate, then it may be desirable to use a catalyst such as a titanium catalyst in the polyol modification reaction. Suitable titanium catalysts include titanium tetraisopropoxide, titanium tetraisobutoxide and the like.

These modified carboxylated polyolefin resins are readily soluble in typical coating solvents such as toluene, xylene, naphtha, mineral spirits, hexane, and ester solvents such as propyl acetate and butyl acetate as well as ketones such as methyl amyl ketone. Mixtures of solvents may be used if desired.

The modified carboxylated polyolefins of the present invention may also contain pendant carboxyl groups, which have the propensity to form hydrophilic salts with amines and therefore may allow the modified polyolefins to be rendered water-dispersible. The modified carboxylated polyolefin may contain a combination of both hydroxyester and carboxylic acid functional groups. For example, this can be accomplished by reacting an anhydride functional polyolefin with one mole of 2,2,4-trimethyl-1,3-pentanediol to yield a modified carboxylated polyolefin containing both hydroxyester and carboxylic acid functional groups.

It is readily understood by one skilled in the art that the modified carboxylated polyolefins containing both pendant hydroxyl groups and pendant carboxyl groups, may also be rendered water-dispersible. These modified carboxylated polyolefins may be dispersed by emulsifying the modified carboxylated polyolefin in the presence of a nonionic surfactant, amine, and water. The total amount of modified carboxylated polyolefin in this composition is not significant as long as the relative amounts of surfactant and amine are within typically used ranges for these materials.

The surfactants useful in this invention may be broadly described as nonionic surfactants. The surfactants may have a molecular weight of up to 500 or greater and may include polymeric materials. The surfactants include materials which contain groups of varying polarity whereby one part of the molecule is hydrophilic and the other part of the molecule is hydrophobic. Examples of such materials include polyethyleneoxy polyols and ethoxylated alkyl phenols. Particularly preferred classes of surfactants include alkyl phenoxy poly(ethyleneoxy) alcohols, primary ethoxylated alcohols and secondary ethoxylated alcohols. Preferably the surfactant is a primary ethoxylated alcohol having 12 to 15 carbon atoms or a secondary ethoxylated alcohol having 11 to 15 carbon atoms. Examples of alkyl phenoxy poly(ethyleneoxy) alcohols include Igepal CO-710 sold by Rhone Poulenc. Examples of primary ethoxylated alcohols include Neodol 25-9 and Neodol 25-12 sold by Shell Chemical Company. Examples of secondary ethoxylated alcohols include Tergitol 15-S-9 and Tergitol 15-S-15 sold by Union Carbide Company. The amount of surfactant is broadly in the range of 18 to 50 weight percent and is preferably in the range of 20 to 25 weight percent, based on the weight of the modified carboxylated polyolefin.

The amine component may be a primary, secondary, or tertiary amine. The amine may be aromatic or aliphatic, but aliphatic amines are preferred. The amount of amine may be in the range of 4 to 30 weight percent and preferably is in the range of 8 to 10 weight percent, based on the weight of the modified carboxylated polyolefin. The amount of water may vary widely and there is no upper limit on the amount of water used. There may be a lower limit on the amount of water because sufficient water should be present in the composition to result in the formation of an admixture of the four components. Generally, there should be at least 50 weight percent water in the composition, based on the weight of the total composition.

The modified carboxylated polyolefins of the present invention are readily used as primers for plastic and metal substrates prior to painting. The modified carboxylated polyolefins may be used as prepared or further diluted with any of the solvents listed previously. The water-dispersible versions may also be applied to the substrate as prepared or they may be further diluted with water. Both the solvent and water-based materials may be applied to the substrate by spray application, dipping, or any other means available, which allows for a uniform coating of the modified carboxylated polyolefin onto the substrate.

These modified carboxylated polyolefins may also be used as additives for paint topcoats. In this instance, the modified carboxylated polyolefin may be added to the coating prior to application on a substrate. When subsequent topcoats, such as melamine or urethane based topcoats, are used with the primers of the present invention, it is believed that the free hydroxyl and carboxyl groups in the modified carboxylated polyolefin primers of the present invention may react with reactive groups in the topcoat, for example, the methylol groups in melamine resins. This interaction may be responsible for the excellent adhesion, solvent resistance, water resistance and other properties of these coatings.

This invention can be further illustrated by the following examples of preferred embodiments thereof, although it will be understood that these examples are included merely for purposes of illustration and are not intended to limit the scope of the invention unless otherwise specifically indicated.

### EXAMPLES

The following tests were used to evaluate the performance of the various modified polyolefins of the present invention:

Gasoline Resistance (Abbreviated Description of GM 9501P Method B)

Painted test samples are scribed with a sharp knife to make 100 squares. The scribed test samples are immersed in a 55/45 VM&P naphtha/toluene mixture and covered with aluminum foil. After 15 minutes immersion, the test samples are evaluated for number of squares removed or blistered. This is repeated every 15 minutes until the test samples have been immersed for 60 minutes, or all squares are removed. The percent paint removed and the percent paint retained is reported at each evaluation period, and the blistering.

Cross-cut Tape Test (Abbreviated Description of ASTM 3359 Method B)

Painted test samples are scribed with a sharp knife to make 25 squares. The center of a piece of tape is placed over the scribed area and the tape is rubbed firmly into place with a pencil eraser or other object. The tape is removed by seizing the free end and by rapidly peeling it back on itself as close to a 90-degree angle as possible. The percent paint retained is reported.

Humidity Resistance (Abbreviated Description of ASTM D 4585)

Test specimens are mounted, with the painted side facing the inside of the Cleveland Humidity cabinet. All cracks are closed between specimens to prevent vapor loss and temperature variation. The thermostat is adjusted to set the vapor temperature at 120° C. The test specimens are removed periodically, and tested by the cross-cut tape test method for adhesion and blister formation.

### Example 1

### Comparative Example

To a 1-L, 3-neck round bottom flask equipped with a mechanical overhead stirrer, condenser, addition funnel, and a nitrogen inlet was charged 275 grams tert-butyl benzene and 150.0 grams of a propylene-ethylene copolymer comprised of about 80 mole percent propylene and about 20 mole percent ethylene (available from Eastman Chemical Company as Eastman Eastoflex E-1200® amorphous propylene-ethylene copolymer). The copolymer had a Ring and Ball Softening Point of 135° C. The mixture was heated to 150 degrees C over 45 minutes to provide a colorless solution. Maleic anhydride (12.0 grams) and 2,5-bis (tert-butylperoxy)-2,5-dimethylhexane (4.8 grams, radical initiator) were dissolved in 15.0 grams of acetone. The resulting solution of maleic anhydride/acetone/radical initiator was transferred to the addition funnel and charged to the reaction flask over 40 minutes. The contents of the flask were stirred for an additional 4 hours at 150 degrees C following the addition of the maleic anhydride and the radical initiator. The tert-butylbenzene was distilled from the reaction mixture under vacuum until nothing else distilled from the pot at a temperature of 150 degrees C and a pressure of 50 mm Hg. Xylene (478 grams, mixed isomers) was charged to the molten carboxylated polyolefin over 20 minutes while maintaining the temperature between 116-145 degrees C. The resulting solution of the carboxylated polyolefin in xylene was cooled to room temperature and bottled. Analysis of this material yielded an acid number of 11.6 mg KOH/gram with a solids level of 25.0%. Correcting for %-solids, the acid number value increases to 46.4 mg KOH/gram for 100 percent solid material.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries.

Paint adhesion tests were conducted in accordance with ASTM D3359B method. The results of this test were as follows: percent retained adhesion on Montell Hifax CA 187 AC TPO: 100%.

Cleveland humidity testing was conducted in accordance with ASTM D 4585 in conjunction with ASTM D 3359 at 49° C. The results were as follows: percent retained adhesion after 24 hours exposure: 0%.

Gasoline Resistance was tested using General Motors test GM 9501P Method B. Results were as follows: Percent loss after 1 hour in synthetic fuel mixture (55/45 VM&P naphtha/toluene): 0% with no blistering observed.

This composition was spray applied as a primer onto thermoplastic olefin (TPO) test plaques and air-dried for 10 minutes. After application of the primer, the panels were topcoated with an OEM 2- package urethane basecoat (206LE19689K) and clearcoat (317LE19929) from Red Spot Paint & Varnish.

Paint adhesion tests were conducted in accordance with ASTM D3359B method. The results of this test were as follows: percent retained adhesion on Montell Hifax CA 187 AC TPO: 100%.

Cleveland humidity testing was conducted in accordance with ASTM D 4585 in conjunction with ASTM D 3359 at 49° C. The results were as follows: percent retained adhesion after 48 hours exposure: 100%; percent retained adhesion after 192 hours exposure: 100%; percent retained adhesion after 504 hours exposure: 100%

Gasoline Resistance was tested using General Motors test GM 9501P Method B. Results were as follows: Percent loss after 1 hour in synthetic fuel mixture (55/45 VM&P naphtha/toluene): 0%, but with 50% blistering observed.

Thus, this example shows that this non-chlorinated, carboxylated polyolefin adhesion promoter does not provide good high temperature and humidity resistance with the melamine-cured coating.

### Example 2

### Comparative Example

A propylene-ethylene copolymer comprised of approximately 80 mole percent propylene and 20-mole percent ethylene was dissolved in xylene at 5% solids. The solution was filtered to remove any undissolved polymer that might be present in the mixture. This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

The primed panels were topcoated with an OEM 2-package urethane basecoat (206LE19689K) and clearcoat (317LE19929) from Red Spot Paint & Varnish. Test results are listed in Table 1.

This is an example of a propylene-ethylene copolymer containing no hydroxyl or carboxyl functionality that does not perform well as an adhesion promoter for polyolefin surfaces.

### Example 3

To a 500-ml, 3-neck round bottom flask equipped with a mechanical overhead stirrer, thermocouple, nitrogen purge, Dean-Stark trap, and a condenser was charged 138.9 grams of a maleic anhydride modified (carboxylated) polymer (25% in xylene) prepared as described in Example 1 and 1.7 grams of trimethylolethane (1,1,1-tris (hydroxymethyl) ethane). The mixture was heated to 120° C. and held there with stirring for 40 minutes. The reaction mixture was cooled to 80-90° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides excellent adhesion of urethane and melamine-cured coatings onto polyolefin surfaces and provides excellent high temperature and humidity resistance.

### Example 4

To a 500-ml, 3-neck round bottom flask equipped with a mechanical overhead stirrer, thermocouple, nitrogen purge, Dean-Stark trap, and a condenser was charged 197.3 grams of a maleic anhydride modified (carboxylated) polymer (25% in xylene) prepared as described in Example 1 and 2.36 grams of 1,6-hexanediol. The mixture was heated to 120° C. and held there with stirring for 30 minutes. The reaction mixture was cooled to 80-90° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides excellent adhesion of urethane and melamine-cured coatings onto polyolefin surfaces and provides excellent high temperature and humidity resistance.

### Example 5

To a 500-ml, 3-neck round bottom flask equipped with a mechanical overhead stirrer, thermocouple, nitrogen purge, Dean-Stark trap, and a condenser was charged 250.0 grams of a maleic anhydride modified (carboxylated) polymer (25% in xylene) prepared as described in Example 1 and 3.80 grams of 2,2,4-trimethyl-1,3-pentanediol. The mixture was heated to 80° C. and held there with stirring for 1.5 hours. The reaction mixture was cooled to 50-60° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides improved high temperature and humidity resistance of a melamine cured coating onto polyolefin surfaces relative to Comparative Examples 1 and 2.

### Example 6

To a 500-ml, 3-neck round bottom flask equipped with a mechanical overhead stirrer, thermocouple, nitrogen purge, Dean-Stark trap, and a condenser was charged 250.0 grams of a maleic anhydride modified (carboxylated) polymer (25% in xylene) prepared as described in Example 1 and 7.60 grams of 2,2,4-trimethyl-1,3-pentanediol. The mixture was heated to 80° C. and held there with stirring for 1.5 hours. The reaction mixture was cooled to 50-60° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides improved high temperature and humidity resistance of a melamine cured coating onto polyolefin surfaces relative to Comparative Examples 1 and 2.

### Example 7

To a 500-ml, 3-neck round bottom flask equipped with a mechanical overhead stirrer, thermocouple, nitrogen purge, Dean-Stark trap, and a condenser was charged 250.0 grams of a maleic anhydride modified (carboxylated) polymer (25% in xylene) prepared as described in Example 1 and 3.88 grams of propylene glycol. The mixture was heated to 80° C. and held there with stirring for 1.5 hours. The reaction mixture was cooled to 50-60° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides improved high temperature and humidity resistance of a melamine cured coating onto polyolefin surfaces relative to Comparative Examples 1 and 2.

### Example 8

To a 500-ml, 3-neck round bottom flask equipped with a mechanical overhead stirrer, thermocouple, nitrogen purge, Dean-Stark trap, and a condenser was charged 25.0 g of methyl ethyl ketone and 3.72 grams of trimethylolethane (1,1,1-tris (hydroxymethyl) ethane). The mixture was heated to 75-80° C. and was stirred at this temperature until the trimethylolethane had dissolved. To this mixture was added, over approximately 35 minutes, 125.0 grams of a maleic anhydride modified (carboxylated) polymer (25% in xylene) prepared as described in Example 1. After the addition the mixture was stirred at 85° C. for 2 hours. After 2 hours the addition funnel was replaced with a Dean-Stark trap and the low-boilers (MEK) were removed using a nitrogen sparge. The reaction mixture was cooled to 50-60° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides improved high temperature and humidity resistance of a melamine cured coating onto polyolefin surfaces relative to Comparative Examples 1 and 2.

### Example 9

To a 500-ml, 3-neck round bottom flask equipped with a mechanical overhead stirrer, thermocouple, nitrogen purge, Dean-Stark trap, and a condenser was charged 250.0 grams of a maleic anhydride modified (carboxylated) polymer (25% in xylene) prepared as described in Example 1 and 4.60 grams of 1,3-butanediol. The mixture was heated to 80° C. and held there with stirring for 1.5 hours. The reaction mixture was cooled to 50-60° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides improved high temperature and humidity resistance of a melamine cured coating onto polyolefin surfaces relative to Comparative Examples 1 and 2.

### Example 10

To a 500-ml, 3-neck round bottom flask equipped with a mechanical overhead stirrer, thermocouple, nitrogen purge, Dean-Stark trap, and a condenser was charged 250.0 grams of a maleic anhydride modified (carboxylated) polymer (25% in xylene) prepared as described in Example 1 and 7.46 grams of 2-ethyl-1,3-hexanediol. The mixture was heated to 85° C. and held there with stirring for 1.5 hours. The reaction mixture was cooled to 50-60° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides excellent high temperature and humidity resistance of a melamine cured coating and urethane cured coating onto polyolefin surfaces relative to Comparative Examples 1 and 2.

### Example 11

To a 500-ml, 3-neck round bottom flask equipped with a mechanical overhead stirrer, thermocouple, nitrogen purge, Dean-Stark trap, and a condenser was charged 150.0 grams of a maleic anhydride modified (carboxylated) polymer (25% in xylene) prepared as described in Example 1 and 7.50 grams of Eastman Reactol 100 (acrylic polyol; hydroxyl #= 100). The mixture was heated to 85° C. and held there with stirring for 2.0 hours. The reaction mixture was cooled to 60-70° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE19689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides excellent high temperature and humidity resistance of a melamine cured coating and urethane cured coating onto polyolefin surfaces relative to Comparative Examples 1 and 2.

### Example 12

To a 1-L, 3-neck round bottom flask equipped with a mechanical overhead stirrer, condenser, addition funnel, and a nitrogen inlet was charged 550 grams tert-butyl benzene and 300.0 grams of a propylene-ethylene copolymer comprised of about 80 mole percent propylene and about 20 mole percent ethylene. The copolymer had a Ring and Ball Softening Point of 135° C. The mixture was heated to 150 degrees C over 45 minutes to provide a colorless solution. Maleic anhydride (36.0 grams) and 2,5-bis(tert-butylperoxy)-2,5-dimethylhexane (14.4 grams, radical initiator) were dissolved in 46.2 grams of acetone. The resulting solution of maleic anhydride/acetone/radical initiator was transferred to the addition funnel and charged to the reaction flask over 60 minutes. The contents of the flask were stirred for an additional 4 hours at 150 degrees C following the addition of the maleic anhydride and the radical initiator. The tert-butylbenzene was distilled from the reaction mixture under vacuum until nothing else distilled from the pot at a temperature of 150 degrees C and a pressure of 50 mm Hg. Xylene (960 grams, mixed isomers) was charged to the molten carboxylated polyolefin over 30 minutes while maintaining the temperature at 125 degrees C. The resulting solution of the carboxylated polyolefin in xylene was cooled to room temperature and bottled.

To a 500-ml, 3-neck round bottom flask equipped with an overhead stirrer, condenser, thermocouple, and a nitrogen inlet was charged 150.0 grams of the carboxylated polyolefin solution prepared as described above, 12.3 grams of 2-ethyl-1,3-hexanediol, and 0.05 grams of p-toluenesulfonic acid. The mixture was heated to 100° C. and held at this temperature with stirring for 5 hours. The reaction mixture was cooled to 60-70° C. and poured into a glass container. This reaction mixture was reduced to 5% in toluene for spray application.

This composition was spray applied as a primer onto thermoplastic olefin (TPO) test plaques and air-dried for 10 minutes. After application of the primer, the panels were topcoated with an OEM melamine-cured basecoat (Durethane 802) and clearcoat (UCC 1001) from PPG Industries. Test results are listed in Table 1.

This composition was spray applied as a primer onto thermoplastic olefin (TPO) test plaques and air-dried for 10 minutes. After application of the primer, the panels were topcoated with an OEM 2-package urethane basecoat (206LE1 9689K) and clearcoat (317LE19929) from Red Spot Paint & Varnish. Test results are listed in Table 1.

This is an example of a carboxylated polyolefin that has been modified with a polyfunctional alcohol to yield an adhesion promoter that provides excellent high temperature and humidity resistance of a melamine cured coating and urethane cured coating onto polyolefin surfaces.

### Example 13

To a 3-L, 3-neck round bottom flask equipped with a mechanical overhead stirrer, condenser, thermocouple, and a nitrogen inlet was added 2250 grams of a commercially available carboxylated polyolefin supplied 25% in xylene (AP 440-1 carboxylated polyolefin from Eastman Chemical Company). This material was heated to 90° C. To this material was added, at 90° C, 134.2 grams of 2-ethyl-1,3-hexanediol over approximately 15 minutes. The mixture was stirred at 90° C. for 4 hours. The mixture was cooled to 60-70° C. and poured into a glass container. To a 500-ml, 3-neck round bottom flask equipped with a vacuum distilling head, overhead stirrer, and a thermocouple was added 350.0 g of the solution prepared as described above. This mixture was heated to 90° C. and the pressure inside the reactor was gradually reduced to strip off the solvent (xylene) from the carboxylated polyolefin solution. The pressure inside the reactor was gradually reduced from 760 to 19 mmHg. The temperature was gradually increased to 120° C. to help remove any of the remaining solvent. To a Parr Reactor was added 25.0 grams of solid 2-ethyl-1,3-hexanediol modified carboxylated polyolefin (recovered from the solvent-stripping step above), 6.0 grams of Triton N-101 (ethoxylated alkylphenol surfactant), 1.75 grams of 2-amino-2-methyl-1-propanol, and 97.0 grams of water. The reactor was sealed and heated to 150° C. The mixture was held at 150° C. with stirring for 2 hours. The mixture was then heated to 170° C. and was held at this temperature for another hour. The mixture was then cooled as quickly as possible and was poured into a glass container. The mixture was very translucent and there was only a small amount (<1.0 g) of solid remaining on the walls of the reactor. The pH of the emulsion was approximately 10.

This example demonstrates the ability to disperse the modified carboxylated polyolefins of the present invention into water using a surfactant, amine, and water.

TABLE 1
Crosshatch Adhesion Tape Test and Gasoline Resistance

| | | | Adhesion | |
|---|---|---|---|---|
| | | | After | |
| | | | Humidity | |
| | | | (When | |
| | | Initial | failure | |
| | | Adhesion | occurred) | Gasoline |
| | Topcoat | (ASTM | (ASTM | Resistance |
| Example # | System | 3359) | D4585) | (GM 9501P) |
| 1 | 2-package | 100% | 100% | 100% (50% |
| (Comparative) | urethane | | (No failure at | blistering) |
| | | | 504 Hrs.) | |
| 1 | 1-package | 100% | 0% @ 24 | 100% |
| (Comparative) | melamine | | Hrs. | (No blistering) |
| 2 | 2-package | 0% | NA | 0% |
| (Comparative) | urethane | | | (after 10 min.) |
| 2 | 1-package | 0% | NA | 0% |
| (Comparative) | melamine | | | (after 30 min.) |
| 3 | 2-package | 100% | (No failure at | 100% |
| | urethane | | 504 Hrs.) | (No blistering) |
| 3 | 1-package | 100% | (No failure at | 100% |
| | melamine | | 504 Hrs.) | (No blistering) |
| 4 | 2-package | 100% | (No failure at | 100% (50% |
| | urethane | | 504 Hrs.) | blistering) |
| 4 | 1-package | 100% | 100% at 96 | 100% |
| | melamine | | Hrs. (87% at | (No blistering) |
| | | | 192 Hrs.) | |
| 5 | 2-package | 100% | 100% | 100% |
| | urethane | | (No failure at | (No blistering) |
| | | | 504 Hrs.) | |
| 5 | 1-package | 100% | 100% at 48 | 100% |
| | melamine | | Hrs. (0% at 96 | (No blistering) |
| | | | Hrs.) | |
| 6 | 2-package | 100% | 100% | 100% |
| | urethane | | (No failure at | (No blistering) |
| | | | 504 Hrs.) | |
| 6 | 1-package | 100% | 100% at 48 | 100% |
| | melamine | | Hrs. (0% at 96 | (No blistering) |
| | | | Hrs.) | |
| 7 | 2-package | 100% | 100% | 100% |
| | urethane | | (No failure at | (No blistering) |
| | | | 504 Hrs.) | |
| 7 | 1-package | 100% | 96% at 48 | 100% |
| | melamine | | Hrs. (0% at | (No blistering) |
| | | | 120 Hrs.) | |
| 8 | 2-package | 100% | 100% | 100% |
| | urethane | | (No failure at | (No blistering) |
| | | | 504 Hrs.) | |
| 8 | 1-package | 100% | 100% at 48 | 100% |
| | melamine | | Hrs. (0% at | (No blistering) |
| | | | 120 Hrs.) | |
| 9 | 2-package | 100% | 100% | 100% |
| | urethane | | (No failure at | (No blistering) |
| | | | 504 Hrs.) | |
| 9 | 1-package | 100% | 100% at 48 | 100% |
| | melamine | | Hrs. (0% at | (No blistering) |
| | | | 120 Hrs.) | |
| 10 | 2-package | 100% | 100% | 100% |
| | urethane | | (No failure at | (No blistering) |
| | | | 528 Hrs.) | |
| 10 | 1-package | 100% | 100% (Failure | 100% |
| | melamine | | between | (No blistering) |
| | | | 264-528 Hrs.) | |
| 11 | 2-package | 100% | 100% | 100% |
| | urethane | | (No failure at | (No blistering) |
| | | | 528 Hrs.) | |
| 11 | 1-package | 100% | 100% at 48 | 100% |
| | melamine | | Hrs. (55% at | (No blistering) |
| | | | 96 Hrs.) | |
| 12 | 2-package | 100% | 100% | 100% |
| | urethane | | (No failure at | (No blistering) |
| | | | 504 Hrs.) | |
| 12 | 1-package | 100% | 100% | 100% |
| | melamine | | (No failure at | (No blistering) |
| | | | 504 Hrs.) | |

The invention has been described in detailed with particular reference to preferred embodiments thereof, but it will be understood that variations and modifications can be effected within the spirt and scope of the invention.

What is claimed is:

1. A modified carboxylated polyolefin comprising the reaction product of carboxylated polyolefins with one or more polyfunctional alcohols.

2. The modified carboxylated polyolefin of claim 1 wherein the carboxylated polyolefin is obtained by the reaction of a polyolefin polymer selected from the group consisting of polyethylene, ethylene copolymers containing alpha olefins having 2 to about 10 carbon atoms, polypropylene, propylene copolymers containing ethylene or alpha olefins having from 4 to about 10 carbon atoms, poly(1-butene), 1-butene copolymers containing ethylene or alpha olefins having 3 to about 10 carbon atoms; with monomers selected from the group consisting of unsaturated esters, unsaturated acids, unsaturated anhydrides, vinyl monomers, acrylic monomers or mixtures thereof.

3. The modified carboxylated polyolefin of claim 2 wherein the polyolefin polymer is an ethylene-propylene copolymer comprised of about 80 mole percent propylene and about 20 mole percent ethylene.

4. The modified carboxylated polyolefin of claim 2 wherein the unsaturated esters, unsaturated acids, unsaturated anhydrides, vinyl monomers and acrylic monomers are selected from the group consisting of but not limited to maleic anhydride, citraconic anhydride, itaconic anhydride, glutaconic anhydride, 2,3-dimethylmaleic anhydride, maleic acid, fumaric acid, citraconic acid, mesaconic acid, glutaconic acid, acrylic acid, methacrylic acid, crotonic acid, 2-pentenoic acid, 2-methyl-2-pentenoic acid, dimethyl maleate, diethyl maleate, di-n-propyl maleate, diisopropyl maleate, dimethyl fumarate, diethyl fumarate, di-n-propyl fumarate, diisopropyl fumarate, dimethyl itaconate, methyl acrylate, hydroxyethyl acrylate ethyl acrylate, methyl methacrylate, ethyl methacrylate, methyl crotonate, ethyl crotonate, hydroxyethyl acrylate, hydroxyethyl methacrylate, hydroxypropyl acrylate, hydroxypropyl methacrylate and mixtures thereof.

5. The modified carboxylated polyolefin of claim 1 wherein the polyfunctional alcohol is selected from the group consisting of trimethylolethane, pentaerythritol, trimethylolpropane, 1,6-hexanediol, 1,4-cyclohexanediol, 1,4-cyclohexanedimethanol, 2,2,4-trimethyl-1,3-pentanediol, 2-ethyl-1,3-hexanediol, diethylene glycol, triethylene glycol, polyethylene glycols, glycerol, polyester polyols, acrylic polyols, polyurethanepolyols, glucose, sucrose and the like.

6. A solvent-based primer composition comprising the modified carboxylated polyolefin of claim 1; and a solvent.

7. The solvent-based primer composition of claim 6 wherein the solvent is selected from the group consisting of ester solvents, ketone solvents, aliphatic solvents, aromatic solvents and mixtures thereof.

8. A water-based primer composition comprising the modified carboxylated polyolefin of claim 1; a surfactant, an amine and water.

9. The water-based primer composition of claim 8 wherein said surfactant is a nonionic surfactant.

10. The water-based primer composition of claim 8 wherein said amine is a primary, secondary or tertiary amine.

11. The water-based primer composition of claim 10 wherein said amine is aliphatic.

12. A self-priming paint composition comprising a paint formulation admixed with the modified carboxylated polyolefin of claim 1.

13. An article of manufacture comprising a plastic or metal substrate, a primer coating comprising the solvent-based primer composition of claim 6 and a topcoat comprising melamine and/or urethane.

14. An article of manufacture comprising a plastic or metal substrate, a primer coating comprising the water-based primer composition of claim 8 and a topcoat comprising melamine and/or urethane.
